(19) United States
(12) Patent Application Publication
(10) Pub. No.: US 2020/0334967 A1
(43) Pub. Date: Oct. 22, 2020

(54) Monitor and System for Monitoring

(71) Applicant: Connido Limited, London (GB)

(72) Inventors: Naveen Sharma, London (GB); Romi Geevarghese Mathew, Solihull (GB); Jalmar Bergman, London (GB)

(21) Appl. No.: 16/763,447

(22) PCT Filed: Oct. 10, 2017
(86) PCT No.: PCT/EP2017/075837

§ 371 Date: May 12, 2020

(51) Int. Cl. G08B 21/02; G08B 25/00; H04W 4/02; H04W 4/029; G06N 20/00; G06F 1/16

(52) U.S. Cl. CPC G08B 21/0211; G08B 21/0288; G08B 25/009; G06F 1/163; H04W 4/029; G06N 20/00; H04W 4/027

(57) ABSTRACT

With reference to FIG. 1 of the drawings, the present invention relates to a system for monitoring the well-being of a subject person, comprising: a subject monitoring device including: a subject sensor operable to detect a condition of the subject or the environment of the subject, and a subject communication device; a carer device including: a carer sensor operable to detect a condition of the carer, a carer communication device, and an alert mechanism for alerting a user of the device including at least one of: a visual display, a speaker, or a physical stimulus device; and a control device including: a processor, a memory, and a communication device operable to be communicatively coupled with the subject communication device and with the carer device, and configured to: receive sensor data from the subject monitoring device and carer device; store the sensor data in the memory; process the sensor data according to a first set of rules; and determine a status based on the processed sensor data; wherein the control device is operable to communicate the determined status to the carer device; and wherein the subject monitoring device further includes a processor operable to process sensor data received from the subject sensor according to a second set of rules, such that an alert is determined if the subject sensor data satisfies one or more of the second set of rules, wherein on determining an alert the subject monitoring device is operable to communicate the alert to the carer device so as to cause the alert mechanism to alert the user of the carer device.

### DESCRIPTION OF INVENTION

This invention relates to a monitor for monitoring the condition of a subject or the subject's environment, and to a system for monitoring the same.

It is known to monitor the condition of a baby, or small child, using a monitoring device. Such monitoring devices typically include a sensor of some type (such as a thermometer, or heart rate monitor) to establish a status or condition of the baby being monitored. The monitors typically alert a parent or guardian, in the event that the monitored baby exhibits an abnormal temperature, respiratory rate or heart rate, so that the parent may take appropriate action.

Baby listening monitors are also known, providing a microphone by which to transmit noises from the baby's cot or crib to the parents, when the parents are away from the baby. Typically, such devices are used when a baby is put to bed, so that parents can monitor whether or not the baby is asleep or awake, and so that the parents are made aware if the baby starts to cry or sounds unsettled.

There are problems associated with known monitoring systems. For example, the parents may not wish to carry the monitor around with them while they are away from baby, and may not wish to be in constant communication via the monitor. For example, if a baby cries, and the parents wish to allow the baby to cry without going to the baby—for example, to prevent the baby seeking constant attention by crying—the parent has no choice other than to listen to the crying over the monitoring system, or else to turn off the monitor. The parents may not wish to turn off the monitor, in case the situation deteriorates and the baby really does need urgent attention.

Furthermore, known systems do not provide analysis of the conditions being monitored, and are reliant on predetermined thresholds being triggered in order to activate an alarm. It would be beneficial for a monitoring system to adapt to the behaviour pattern of the baby, and the parents, in order to provide the information required by the parents to ensure the baby is being monitored appropriately and ensure the baby's well-being. Known systems do not take into consideration that the behaviour of the parent or guardian, and possibly also other persons having frequent contact with the baby such as siblings or grandparents, can be just as important as the behaviour of the baby when determining how to effectively monitor the baby.

Getting a baby to follow a regular sleep and eating routine is challenging and takes patience, discipline and knowledge. With good routine, parents can have more sleep and time to do other things which are the most important concerns as reported by parents. Furthermore, knowing if a baby is healthy and safe can be difficult, and sometimes identifying a health problem requires biometric information or clinical expertise. Parents are concerned about their child's health in the short and long-terms. Collecting the right information and interpreting it can alleviate this concern by keeping the child safe, and ensuring that the child has a healthy routine. However, for many parents, taking care of a baby consumes much of their time and doesn't leave any time for their own well-being (i.e. sleep and socializing). This is especially the case for single parents. This can lead to parents feeling isolated, tired, stressed, and potentially depressed.

According to an aspect of the invention we provide a system for monitoring the well-being of a subject person, comprising: a subject monitoring device including: a subject sensor operable to detect a condition of the subject or the environment of the subject, and a subject communication device; a carer device including: a carer sensor operable to detect a condition of the carer, a carer communication device, and an alert mechanism for alerting a user of the device including at least one of: a visual display, a speaker, or a physical stimulus device; and a control device including: a processor, a memory, and a communication device operable to be communicatively coupled with the subject communication device and with the carer device, and configured to: receive sensor data from the subject monitoring device and carer device; store the sensor data in the memory; process the sensor data according to a first set of rules; and determine a status based on the processed sensor data; wherein the control device is operable to communicate the determined status to the carer device; and wherein the subject monitoring device further includes a processor operable to process sensor data received from the subject sensor according to a second set of rules, such that an alert is determined if the subject sensor data satisfies one or more of the second set of rules, wherein on determining an alert the subject monitoring device is operable to communicate the alert to the carer device so as to cause the alert mechanism to alert the user of the carer device.

The subject monitoring device may include a plurality of subject sensors.

The or each subject sensor may be one of the following: an accelerometer, a thermometer, a gyroscopic sensor, a bio-impedance sensor, a galvanic skin sensor, an heart-rate monitor, a magnetometer, a global positioning system receiver, a microphone, and a pressure sensor.

The subject monitoring device may a wearable device for attachment to the skin or clothing of a person.

According to another aspect of the invention we provide a system for monitoring the well-being of a subject person, comprising: a subject monitoring device including a subject sensor operable to detect a condition of the subject or the environment of the subject, and a subject communication device; and one or more control devices having a processor and a memory, at least one of which is operable to: receive subject sensor data from the subject monitoring device, process the sensor data according to a first set of rules; and determine a status based on the processed sensor data according to the first set of rules, such that a status requiring action is set where one or more of the rules is satisfied by the processed data; wherein at least one of the one or more control devices provides a control unit operable to control aspects of the environment of the subject in response to a status requiring action being set, by one or more of playing sound using a speaker, projecting or displaying an image, controlling one or more lighting units, controlling one or more heating devices, controlling a fan or air conditioning unit.

The subject monitoring device may include a microphone and the sensor data includes sound data recorded by the microphone, and the determined status may be representative of the subject being awake or crying.

The subject monitoring device may include an accelerometer and the sensor data includes data indicative of movement recorded by the accelerometer, and the determined status may be representative of the subject being awake.

According to another aspect of the invention, we provide a system for monitoring the well-being of a subject person, comprising: a subject monitoring device including: a subject sensor operable to detect a condition of the subject or the environment of the subject, and a subject communication device; one or more control devices having a processor and a memory, one of the control devices being configured to receive data input by a user either via a user input device provided by the control device or by receiving a communication indicative of the input data from a remote device, to compare the user input data with data received from the subject sensor that is indicative of a condition of the subject or its environment, and to process the user input data and sensor data according to a first set of rules so as to determine a second set of rules for categorising sensor data received from the subject sensor so as to determine a status of the subject based on the sensor data; wherein the system is operable to communicate sensor data from the subject monitoring device to the or another control device, that control device being operable to process the sensor data so as to determine a status of the subject according to the second set of rules, such that a status requiring action is set where one or more of the second rules is satisfied by the processed data.

Embodiments of the invention will now be described, by way of example only, with reference to the following figures, of which:

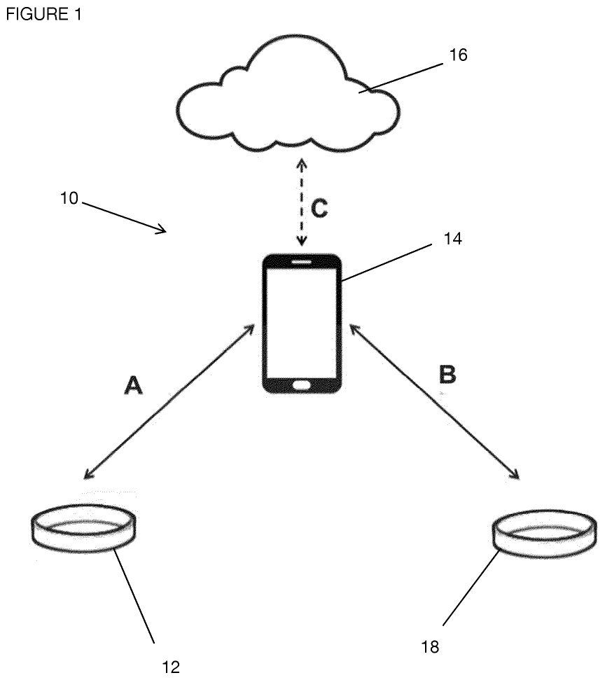

FIG. 1 is a diagrammatic representation of a system according to embodiments of the invention;

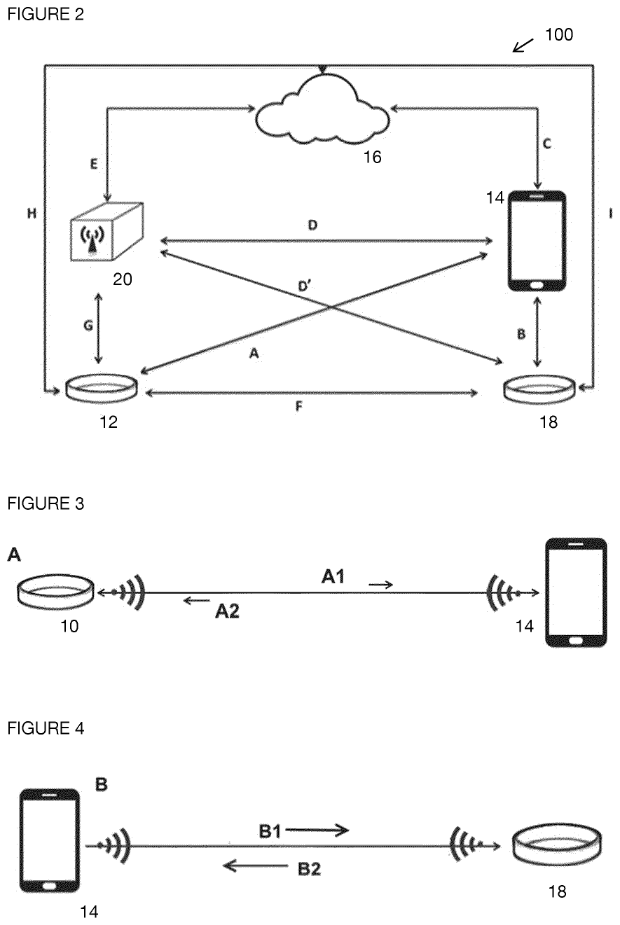

FIG. 2 is a diagrammatic representation of a system according to other embodiments of the invention;

FIGS. 3 to 12 are diagrammatic representations of communication between pairs of devices in the systems of FIGS. 1 and 2;

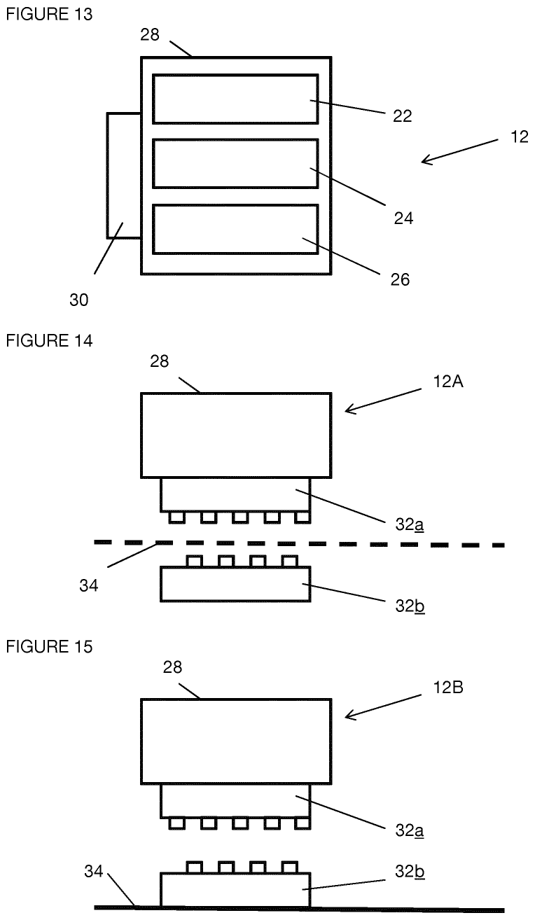

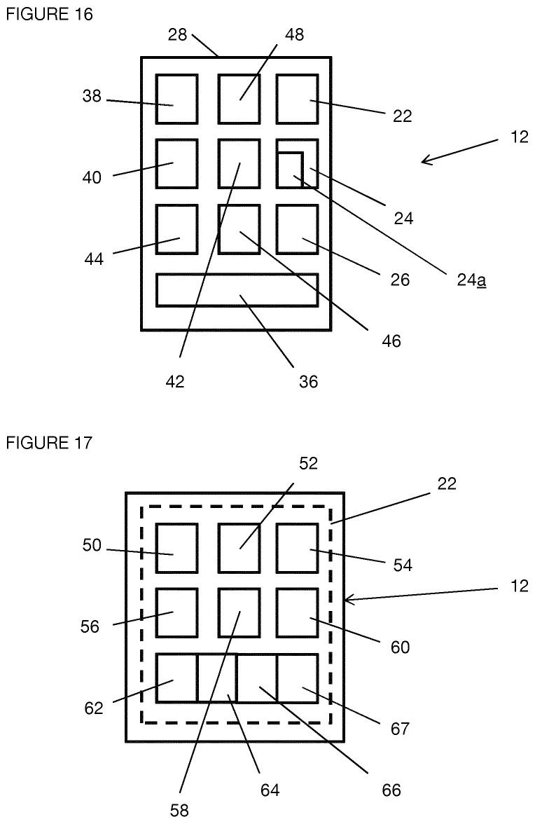

FIGS. 13 to 17 are diagrammatic representations of a subject monitoring device according to embodiments of the invention;

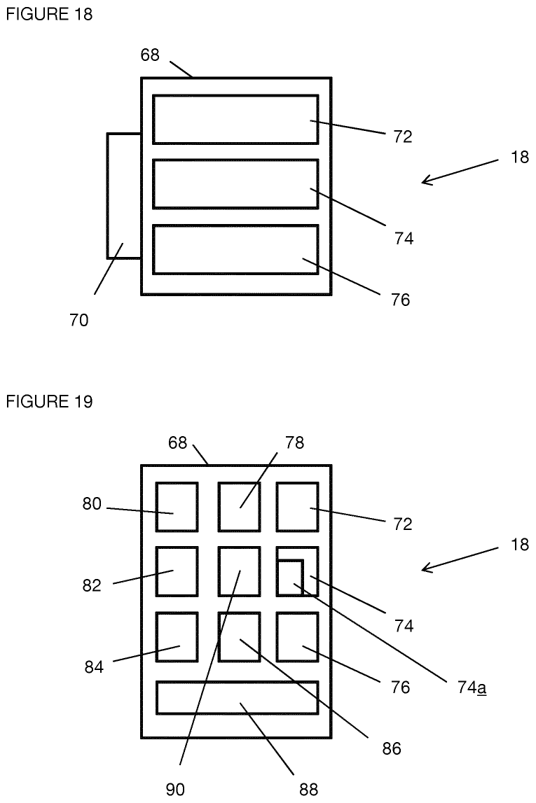

FIGS. 18 and 19 are diagrammatic representations of a carer device according to embodiments of the invention;

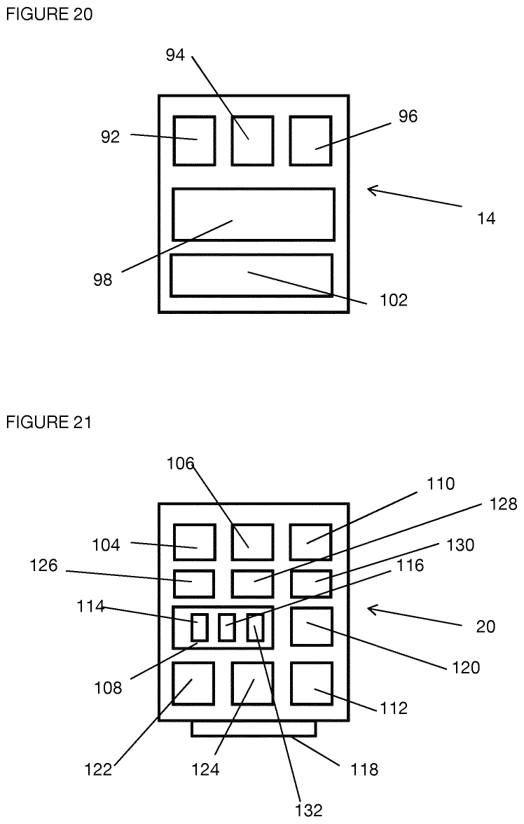

FIG. 20 is a diagrammatic representation of a smart device according to embodiments of the invention;

FIG. 21 is a diagrammatic representation of a base station according to aspects of the invention; and

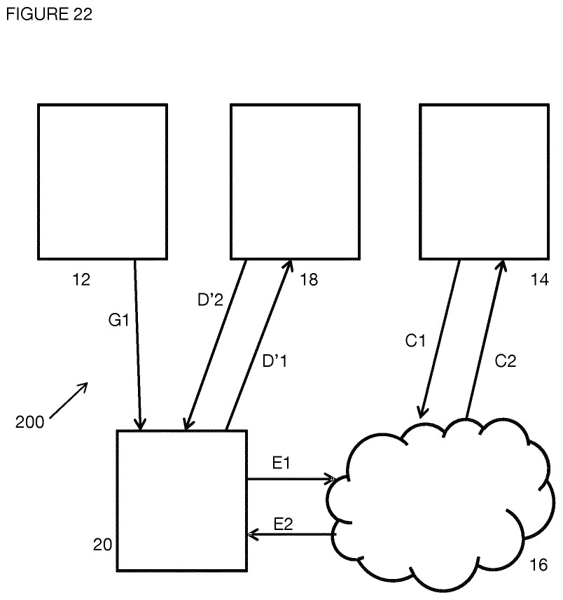

FIG. 22 is a diagrammatic representation of an example system according to embodiments of the invention.

With reference to FIGS. 1 and 2, a system 10, 100 for monitoring a subject is provided. The subject may be a baby or small child. Alternatively, the subject may be an elderly, disabled, or otherwise infirm person, or a person suffering injury, for example. In any case, the subject is a person who is to be monitored. Monitoring in this sense refers to monitoring the well-being of the person, based on data recorded by sensors, relating either to the person being monitored or to the conditions of their immediate environment. For example, monitoring the temperature of the air next to the skin of a person, or monitoring the noise in the direct environment of the person, is equivalent to monitoring the temperature of their skin or the volume of sound being detected by their ears, for the purposes of describing the system. On that basis, references to monitoring a subject are intended to include monitoring the conditions of their immediate environment.

A carer such as a parent, guardian or nurse, for example, is able to use the system 10, 100 of the invention to monitor the condition of the subject, and to take actions as required based on the monitoring information provided by the system.

FIG. 1 illustrates a system 10 in which a subject monitoring device 12 is provided. The subject-monitoring device 12 is described in greater detail below, but in broad terms the device 12 includes a sensor 22 for detecting a condition of the subject being monitored or a condition of the environment of the subject, and a communication device 24 for relaying data to and/or from a remote source.

The subject monitoring device 12 also comprises a power source 26, which may be a battery, for example. Alternatively, the power source 26 may comprise a socket for receiving a wired power connection. The subject monitoring device 12 may be a wearable device that is connected to the subject, or to the subject's clothing, or the device 12 may be positioned adjacent the subject (on a crib or cot, for monitoring a baby, or on a wheelchair or by a bedside of an ill, elderly or disabled person).

In addition to the subject monitoring device 12, the system 10, 100 also includes a carer device 18. The system 10, 100 also provides at least one control device.

The carer device 18 is operable to communicate with at least one control device within the system, and to receive communications from the control device. The carer device 18 may also provide one or more sensors for monitoring a condition of the carer, and shall also be referred to herein using the general term ‘monitoring device’.

The control device receives data from the monitoring device(s) 12, 18 and performs analysis on the data. The or each control device may be operable to determine and/or refine operational rules for the control device and/or one or more of the monitoring devices 12, 18 based on the analysis of the data it receives. Data may be input directly to the control device by a user, or may be received from another source (such as via download from a cloud component of the system 100). The or each control device may be configured to transmit refined or updated operational rules to one or both of the monitoring device(s) 12, 18, which devices may be configured to receive and store the refined or updated operational rules and act upon the stored rules immediately or at a pre-determined time in the future. This updating process may occur in real time, near real time, periodically, on an ad-hoc basis, at the request of monitoring device(s) 12,18, or a combination of any two or more of these options. The or each control device may be configured to select the optimal format for updating operational rules based on considerations such as battery life and/or monitoring device connection availability. This dynamic updating process enables the system to take account of and adapt to changes in the behaviour of the subject and the carer over time, refining the behaviour of the system and tailoring it to the individuals it is working with.

In a preferred configuration, the control device is configured to access and make use of a global dataset when determining and/or refining the operational rules. The global dataset is a population level dataset that comprises data obtained from a plurality of systems like system 100, each system having its own distinct monitoring devices like monitoring devices 12, 18. The global dataset thus contains data relating to the behaviour patterns for a plurality of subjects and carers. Preferably, this data is anonymised to preserve the privacy of the individual subjects associated with the various systems that are performing monitoring. Updated operational rules may be determined based on analysis of the data within the global dataset, perhaps using automated learning algorithms such as machine learning algorithms or artificial neural networks. These updated operational rules may be transmitted to or retrieved by the control device and subsequently transmitted to and stored by one or both monitoring device(s) 12, 18. If both monitoring devices are updated, the updated rules need not be the same—different updated rules may be sent to each monitoring device 12, 18. In embodiments where the control device is cloud component 16 it will be appreciated that cloud component 16 may perform both the data analysis and rules update process.

It will be appreciated from the previous paragraph that the global dataset contains historical data relating to many different individuals. Analysis of this large dataset allows trends, patterns, etc. to be identified that may otherwise go unnoticed at the individual unit (e.g. family) level. This may advantageously allow operational rules to be devised that take account these hitherto unknown trends or patterns, resulting in more efficient and/or more effective monitoring of the subject. Moreover, since data relating to both subject and carer is preferably gathered, the invention may also identify hitherto unknown relationships between the behaviour of the subject and carer and further use this information to devise operational rules for monitoring device(s) 12, 18 that result in more efficient and/or more effective monitoring of the subject.

The global dataset may be divided into a number of partial datasets and operational rules may be generated and/or updated based on one or more of the partial datasets. For example, the global dataset may be divided based on subject-carer relationship time such that each partial dataset contains data gathered from subjects and carers that have been in a subject-carer relationship for a similar period of time. Alternatively, the global dataset may be divided based on the age of the subject and/or the age of the carer, geographical location of the subject and/or carer, etc. Other suitable divisions will be apparent to the skilled person having the benefit of the present disclosure.

In a particularly preferred configuration, the operational rules are devised and/or updated based on both the aforementioned global dataset (or one or more partial datasets thereof) and also a local dataset that contains data relating to only the specific subject and carer associated with system 100. The local dataset may thus be referred to as a family level dataset and the combined dataset may itself be referred to as a dataset, such as a first dataset. In this configuration, operational rules may be created and/or refined based on the global dataset or one or more partial datasets thereof and then further refined based on the local dataset, or vice versa, before being stored on one or both of the monitoring device(s) 12, 18. This ‘two tier’ rule refinement process may allow particularly effective and/or efficient operational rules to be devised, which rules taken account of both specific carer and subject behaviours observed within a particular subject-carer system and also carer and subject behaviours observed more widely in many such subject-carer systems.

It will also be appreciated that the operational rules could alternatively be updated based on the local dataset only, without recourse to the global dataset. Updating the operational rules based on the local dataset only advantageously tailors the operation of the system towards the specific individuals that it is associated with (i.e. the subject(s) and carer(s)). Machine learning such as machine learning algorithms and/or artificial neural networks can be applied to the local dataset in the same manner as described above in respect of the global dataset to identify correlations, trends, patterns etc. and to adjust the operational rules accordingly.

The smart device 14 may be a computer such as a laptop, desktop computer, smart telephone device, or a tablet device. The control device may be a base station 20 device (see FIG. 2, for example). The system 100 may include multiple control devices. The cloud component 16 may comprise the control device.

In some embodiments, and as shown in FIG. 1 of the drawings, the system 10 includes a control device that is a smart device 14, such as a mobile smart-phone as is generally known. The smart device 14 may be a bespoke device specifically configured for the purposes of this system, or else the smart device 14 may be a typical mobile telephone on which an application is installed to provide the functionality described herein.

The smart device 14 is operable to receive communications from the subject monitoring device 12. The communications may provide data gathered by the sensor 22 of the subject monitoring device 12, so that a carer using the smart device 14 may receive updates at predefined intervals. Alternatively or additionally, the carer may receive alert communications indicating that a condition of the subject has been detected which requires attention. For example, the condition may be that the baby is crying, that the temperature in the subject's room has dropped below a certain level, or that the subject has stopped breathing. In each case, the carer monitoring the subject may need to take action to remedy the observed condition.

In embodiments of the invention, the smart device 14 is operable to send communications to the subject monitoring device 12 to request an update on the condition of the subject. The smart device 14 may also be operable to send data to the subject monitoring device 12 to alter the settings or behaviour of the device 12. The smart device 14 may include a memory that is operable to store data received from the subject monitoring device 12.

The system 10 may further include a cloud component 16, providing cloud-based storage for storing data recorded by the subject monitoring device 12, via the smart device 14. The data may be saved in the memory of the smart device 14 prior to being uploaded to the cloud 16, or else may be directly transferred n receipt from the subject-monitoring device 12.

The cloud components 16 may also provide processing components, for performing calculations based on the data received from one or more of the other components of the system 10. As discussed earlier in this specification, the cloud components 16 may receive data from multiple smart devices 14 and subject-monitoring devices 12, that data relating to multiple subjects being monitored. For example, one hundred parents may use the system to monitor their babies, each parent having a respective smart device 14 and subject-monitoring device 12, the data from which is uploaded to a shared cloud component 16 to create the global dataset discussed earlier. In this way, data may be analysed collectively, and patterns observed. For example, the system may receive data describing observations that room temperature dropped below 15 degrees Celsius overnight. It may be determined that following 80% of such observations, data was subsequently obtained that indicated the respective baby had awoken from its sleep and started crying. In this way, the system may determine a threshold below which the temperature should not fall while a baby is sleeping, in order to reduce the likelihood of the baby being awoken due to cold room temperatures. This information may be relayed in the form of operating rules to the smart device 14 in the manner discussed earlier in this specification, so that where an observation is made that the room temperature has fallen to 16 degrees C., and the smart device 14 receives that data from the subject monitoring device 12, the smart device 14 may alert the carer so that pre-emptive action can be taken to raise the room temperature, to avoid the baby waking up.

In embodiments of the system 10 including a carer device 18, that device 18 may be worn by or otherwise associated with the carer. The carer device 18 may include the same components as the subject-monitoring device 12, or a subset of those components, as described herein. The carer device 18 may be worn on the body or clothing of the carer 18, and used to monitor one or more conditions associated with the carer.

The data sensed and monitored by the carer device 18 may be transmitted to the smart device 14, and conversely, data from the smart device may be transmitted to the carer device 18. Data from the carer device 18 may also be uploaded to the cloud component 16, in a similar manner to the data associated with the subject, and included in the global dataset. The data relating to the carer and subject may be amalgamated or linked, and patterns in the two data sets may be observed.

Comparison of data within the system, and determination of rules and observations resulting from this comparison, may take place at any control device—such as the cloud component 16 or at the smart device 14. In other embodiments, where the subject and carer devices 12, 18 comprise microprocessors/microcontrollers (these terms being used interchangeably) and memories, those devices may alternatively or additionally carry out data processing and analysis.

With reference to FIG. 2, the system 100 may include further components, and further channels of communication between system components. For example, in addition to the components described above, the system 100 may include a base station 20 located in proximity to the subject monitoring device 12. For example, where the subject-monitoring device 12 is worn by a baby, the base station 20 may be located in the same room as the baby. The base station 20 is in communication with the subject monitoring device 12.

The base station 20 may be operable to perform the same functionality described above in relation to the smart device 14—communicating with the subject monitoring device, with the carer device, and with the cloud component 16. Further, the base station 20 and smart device 14 may communicate with each other. The base station 20 may include additional sensors to those included in the subject and carer devices 12, 18. The base station 20 may also include further components operable to affect the conditions in the subject's environment, such as the temperature in the room, the amount of light, and to turn music or the like on or off. This is described in greater detail below.

As shown in FIG. 2, each of the components in the system may communicate with each other component in the system 100, as required. The components and operation of the system will now be described in greater detail.

The system 10, 100 may include further devices not described herein, for which compatible software and apps are created using compatible an open API.

### Subject Monitoring Device

The subject monitoring device 12 is typically a wearable device for attachment to the skin or clothing of a person. However, the invention is not limited to this and other forms for the subject monitoring device that enable it to carry out the functionality of monitoring the status of the subject are also contemplated.

In its most basic form, as illustrated in FIG. 13, the subject monitoring device comprises a sensor 22 (a ‘subject sensor’) for detecting a condition of the subject being monitored or a condition of the environment of the subject, and a communication device 24 for relaying data to and/or from a remote source.

The subject monitoring device 12 also comprises a power source 26, which may be a battery, for example. Alternatively, the power source 26 may comprise a socket for receiving a wired power connection.

The subject monitoring device 12 typically includes a body 28 in which the various components are housed, or on which one or more of the components may be mounted. The body 28 may provide a housing configured to surround and protect one or more of the component parts forming the device 12, made of a durable material suitable for withstanding knocks and light impacts. The housing may include padding or cushioning for one or more of the components, so as to soften any impacts, caused by the device 12 being dropped, crushed, struck, bitten, or similar. Optionally, the outer surface of the housing 28 may be treated with an antibacterial agent.

As stated above the subject monitoring device 12 may be a wearable device, configured to be worn by a baby or young child (referred to as ‘the subject’). It is envisaged that the device might alternatively be worn by an elderly or infirm person requiring monitoring or care, or by a person recovering from injury or illness, requiring monitoring, for example.

The subject monitoring device 12 may be configured to be worn around a wrist of the subject. Alternatively, the subject monitoring device 12 may be configured to be worn around a portion of the subject's leg, such as around the ankle, or around the thigh, for example. As a further alternative, the subject monitoring device 12 may be configured to be worn around the neck of the subject. As another alternative, the subject monitoring device 12 may be adapted to be worn around a portion of the subject's arm other than the wrist, such as around a portion of the upper arm. In such cases, the subject monitoring device 12 preferably provides an attachment member 30 such as a strap, or a belt, or another form of attachment mechanism for securing the device 12 relative to the body of the subject.

The subject monitoring device 12 may be connectable to a portion of the subject's clothing. For example, the subject monitoring device 12 may be configured for connection to a portion of a baby's clothing. The subject monitoring device 12 is preferably configured to be attached to and removed from the clothing, so that the clothing can be washed and then the device may be reconnected.

As shown in FIG. 14, the subject monitoring device 12A may provide a connection assembly 32 for connecting the device 12A to a portion of the clothing 34 of the subject. The connection assembly 32 may comprise a first and a second connection part 32a, 32b. The first connection part 32a may be provided on the body 28 of the subject monitoring device 12A and provides a first connection formation, and the second connection part 32b may provide a second connection formation adapted to cooperate with the first connection formation so as to provide a releasable connection between the first and second connection parts 32a, 32b. The second connection part 32b may be placed either inside or outside the article of clothing, and the body 28 of the device 12A providing the first connection part 32a is placed on the other of the inside and outside of the clothing. The first and second connection parts 32a, 32b are then connected to one another, with a portion of the clothing 34 being trapped and held between the two connection parts 32a, 32b, thereby securing the device relative to the article of clothing 34.

As shown in FIG. 15, the item of clothing 34 may be adapted to provide the second connection part 32b, so that the device 12B is attachable to the clothing 34 via connection between the first connection part 32a provided on the body 28 of the device 12B, and the second connection part 32b on the clothing.

The first and second connection parts 32a, 32b may provide corresponding twist-fit formations, clip locking formations, press-fit formations, snap fit formations, as are generally known in the art for securing articles to clothing. The first and second connection parts 32a, 32b may be connected to one another by a hinge, to be secured to an edge portion of an article of clothing (for example, with one part on either side of a sleeve, or a neck of a vest).

It should be understood that the various connection mechanism described above are envisaged to be used interchangeably with any combinations of the other features of the subject monitoring device as described herein.

One or more of the components may be connected to the body 28 of the device 12 by a wired connection, and the component itself may be positioned nearby to the device 12 (but not housed within or directly positioned on the device). The subject monitoring device 12 may be positioned on, or adjacent, a crib or cot of a baby. Alternatively, the subject monitoring device 12 may be formed integrally with a child's toy or other object. For example, the subject monitoring device 12 may be formed within a soft toy, or within a mattress.

In addition to the sensor 22, communication device 24, and power source 26, the subject monitoring device 12 may further comprise one of more of the following components: a microprocessor 36, a display 38, a port for wired data transfer 40, a user input device 42, a physical stimulus device (e.g. such as a motor for causing vibration) 44, a speaker 46, and a memory 48 communicatively coupled to the microcontroller. Each component may be housed at least partially within the body 28 of the device 12. The display 38, input device 42 and wired data transfer port 40 are preferably provided on the body 28 so as to be accessible by a user.

With reference to FIG. 17, the subject monitoring device 12 includes one or more of the following sensors 22: an accelerometer 50, a thermometer 52, a gyroscope/gyroscopic sensor 54, a bio-impedance sensor 56, a galvanic skin sensor 58, a heart-rate monitor 60, a magnetometer 62, a global positioning system receiver 64, a microphone 66, and a pressure sensor 67. It should be understood that where reference is made to a thermometer, the thermometer could be a skin temperature sensor, body temperature sensor or a room temperature sensor, as appropriate. Where a heart-rate monitor 60 is discussed, in relation to any device within the system, that monitor may be an optical heart-rate monitor, for example. It will also be appreciated that any of the aforementioned list of sensors can be substituted by or augmented with sensors suitable for monitoring the subject that are developed in future.

Data generated by the/or each sensor 22 may be stored in the memory 48.

The stored data may be accessed by the microprocessor 36, which is operable to perform calculations on the stored data, to determine patterns, anomalies and/or changes in the data. The memory 48 and/or microprocessor 36 may also store operational rules and settings for the device 12, to determine how it should operate. Microprocessor 36 may be configured to receive one or more updated operational rules from an external source, via port 40 or communication device 24 for example, with microprocessor 36 being further configured to store the updated operational rules in memory 48.

The communication device 24 includes a transmitting device. In addition, the communication device 24 may include a receiver 24a. In such cases the communication device 24 is a transceiver, operable both to send and receive data. Preferably the communication device 24 is operable to transmit (and optionally receive) data wirelessly over a WiFi, Bluetooth, Fourth Generation Long Term Evolutions (4G/LTE), zigbee, Sub 1 giga hertz, z-wave, mesh networking protocols such as Thread, or any other suitable wireless protocol. The communication device 24 may further include a port for wired data transfer 40 (via USB, or a standard network cable, for example). The power source 26 and/or the port 40 may provide a USB connection (such as standard USB, microUSB, miniUSB) suitable both to deliver power to the device and for data communication. The power source 26 may also be wirelessly chargeable, so that a wired charging port is not required.

The contents of the memory 48 and the firmware of the device may also be updated by software/firmware upgrades. These updates may be received via the wireless receiver 24D or via a wired data connection. Such firmware updates are distinct from the updating of one or more operational rules as discussed earlier in this specification, although it will be appreciated that a firmware update could include updated operational rules.

The subject monitoring device 12 may provide a display 38 for displaying information to a user. The display 38 may include one or more visual indicators (e.g. LEDs) operable to indicate a status of the device 12. For example, the display 38 may indicate whether the device 12 is functioning correcting and/or whether it is currently powered by a power source and/or whether it is in communication with one or more other devices in the system. The display 38 may include a screen operable to display data recorded by the sensor(s) 22, or data based on the results of computations by the microprocessor 36.

The subject monitoring device 12 may include a user input device 42 to allow a user to interact directly with the device 12. The input device 42 may include one or more buttons provided on the body 28 of the device 12. The input device 42 may comprise a touch screen display.

The subject monitoring device 12 may include a physical stimulus device, such as a motor for causing the device or a portion of the device to vibrate. It should be understood that wherever a device is said to vibrate, or is said to include a motor for causing vibration, any suitable physical stimulation device may be provided. The device need not be a traditional vibrating device as is commonly provided in mobile telephones, for example, but may include a pressure pad or automatically adjustable strap, to provide a physical stimulus to the user to make the user aware of an alert, for example. For example, a motor may cause an attachment member 30 of the device 12 to tighten or loosen where the device 12 is being worn (e.g. on a wrist, or around a leg). Vibration and/or tightening/loosening may be used to interact with a baby, for example, by applying a pressure against the skin of the baby. This can provide a calming or reassuring effect to soothe the baby. The vibration may also be used to wake the subject, if required. The device 12 may also include or be coupled with a pressure pad for applying a comforting pressure to the subject. Hereinafter, references to a motor should be construed to mean any suitable physical stimulus device.

The subject monitoring device may include a speaker 46 operable to sound an alarm or alert notification in the event that a problem arises. The problem may be associated with the operational condition of the device 12, for example, if a battery is running low, or if the device 12 has been damaged. The speaker 46 may be used to play calming noises, music, of voices to the subject being monitored. This may include recordings of a parent's voice, a lullaby, or sounds of the sea, for example.

Each component may be housed at least partially within the body 28 of the device 12.

The display 38, input device 42 and wired data transfer port 40 are preferably provided on the body 28 so as to be accessible by a user.

The subject monitoring device 12 may include a processor operable to process sensor data received from the sensor(s) of the subject monitoring device. The sensor data is processed according to a set of operational rules stored in a memory of the subject monitoring device 12 or otherwise hardwired or encoded on the device 12, which operational rules may be obtained from and updated by the cloud component 16.

An alert is determined if the sensor data satisfies one or more of those operational rules. For example, a rule may state that if no heartbeat is detected, or if an accelerometer shows a very sudden acceleration, an alert is required. On determining an alert, the subject monitoring device 12 is operable to communicate the alert to the carer device 18 so as to cause an alert mechanism of the carer device 18 to alert the user of the carer device 18. An operational rule may specify multiple criteria that have to be met before an alert is generated; for example, noise above a certain level is detected N times in a period of time not exceeding T minutes, N being an integer and T being a real number.

It should be understood that the rules, conditions and instructions set by the system include target thresholds and target ranges of values, for example. The data “satisfies” those thresholds and/or ranges depending on the nature of the rule, by either lying within, above or below the target values, respectively. For example, a rule may specify a target temperature range within which the subject's skin temperature should stay. An alert may be triggered by the skin temperature of the subject being sensed at a level below a lower threshold, for example. Alternatively, a status of ‘normal’ may be set if the skin temperature falls within the target range (i.e. the condition is met), and otherwise an alert status may be set (i.e. the condition is violated).

For simplicity, where rules and/or thresholds or ranges are discussed, we refer to a “condition being satisfied” to determine an alert and/or a status. It should be understood that, in effect, corresponding rules or instructions are provided that are satisfied in one way if a condition is met, and in another way if the condition is not. So, a threshold for temperature may be satisfied to raise an alert if the temperature falls below the threshold (providing a first rule), and may be satisfied to set a ‘normal’ status if the temperature is above the same threshold (providing a second rule). It will be apparent that there are many equivalent methods for applying values of rules and/or instructions in this way.

Rules may be defined that involve inspection of the status of other components of system 100. For example, a rule may specify that an alert is generated if an audio processing algorithm detects audio signals deemed to be representative of a baby's cry when a location of carer device 18 is determined to be outside of an effective hearing radius centered on the location of subject monitoring device 12, where this radius may be preset or calculated based on the instantaneous or averaged volume of the audio signals. In such cases the determination as to whether to generate an alert may be distributed among the components of system 100, with each component determining if the part of the rule relevant to that component is satisfied. Rules that take account of sensor data from both the subject and carer are also contemplated such that an alert is triggered only when certain behaviours are observed from both the subject and carer. These behaviours may be observed simultaneously or within a predetermined time frame of one another.

The system may include a plurality of subject monitoring devices 12.

### Carer Device

The carer device 18 may be worn on the body or clothing of the carer, and used to monitor one or more conditions associated with the carer. The carer device 18 may be worn around a wrist of the carer (i.e. similar to a watch or smart watch), or may be worn as a band on the arm of the carer. The device 18 may be integrated into a piece of jewellery such as a ring, or worn around the neck.

Alternatively, the device 18 may be fastened to a belt, or to other clothing, using clips, hooks, or any other connection mechanism previously described. The carer device 18 may be a third party device such as a smartwatch or smart fitness band, for example.

As shown in FIG. 18, the carer device 18 may include a communication device 74 for relaying data to and/or from a remote source. The carer device 18 also comprises a power source 76, which may be a battery, for example, or a socket for receiving a wired power connection. The carer device 18 may further include a sensor 72 (a ‘carer sensor’), for detecting a condition of the carer (or a condition of the environment of the carer).

The carer device 18 typically includes a body 68 in which the various components are housed, or on which one or more of the components may be mounted, in the same general manner as the subject monitoring device 12.

The carer device 18 may include a display 78 for displaying information to the carer, such as data communicated to the device 18 by other components in the system 10, 100, or for displaying status information relating to the device 18 (such as power status, operating status, connectivity status, for example). Status information may be displayed on a screen, or via LEDs, or by any other means.

The carer device 18 may include a microprocessor 80 for processing information sensed by the device 18, data received from other system components, and/or data stored in a memory of the device 18.

In addition to the sensor 72, communication device 74, and power source 76, the carer device 18 may further comprise one of more of the following components: a microcontroller 88, a display 78, a port for wired data transfer 80, a user input device 82, a motor for causing vibration 84, a speaker 86, and a memory 90 communicatively coupled to the microcontroller 88. Each component may be housed at least partially within the body 68 of the device 18. The display 78, input device 82 and wired data transfer port 80 are preferably provided on the body 68 so as to be accessible by a user.

The user input device 82 may comprise one or more buttons, switches, dials, and/or touch sensitive controls (such as a touch screen, for example). The vibration motor 84 may be used to alert the carer to an alarm condition, for example. User interactions with user input device 82 can take many forms, including but not limited to: cancelling or registering alerts, manually inputting data such as the time of a specific event e.g. feeding, and entering control commands such as adjusting a volume or adjusting a light level. Other suitable interactions will become apparent to a skilled person having the benefit of this disclosure.

The carer device 18 may include one or more of the following sensors 72, as illustrated in FIG. 17 in relation to the sensors of the subject monitoring device 12. The sensors 72 may include: an accelerometer 50, a thermometer 52, a gyroscope/gyroscopic sensor 54, a bio-impedance sensor 56, a galvanic skin sensor 58, a heart-rate monitor 60, a magnetometer 62, a global positioning system receiver 64, a microphone 66, and a pressure sensor 67. Sensors for detecting the status of the carer that are not currently known but which are developed in future may alternatively or additionally be included in carer device 18.

Data generated by the or each sensor 72 may be stored in the memory 90. The stored data may be accessed by the microprocessor/microcontroller 88, which is operable to perform calculations on the stored data, to determine patterns, anomalies and/or changes in the data. The memory 90 and/or microprocessor 88 may also store operational rules and settings for the device 18, to determine how it should operate. In the same manner as subject monitoring device 12, the stored rules may be updated whenever it is deemed appropriate to do so by contact with a remote device such as cloud component 16. The rules stored in memory 90 are typically different from those stored in the memory of subject monitoring device 12.

The communication device 74 includes a transmitting device. In addition, the communication device 74 may include a receiver 74D. The communication device 74 may be a transceiver, operable both to send and receive data. Preferably the communication device 74 is operable to transmit (and optionally receive) data wirelessly over a WiFi, Bluetooth, Fourth Generation Long Term Evolutions (4G/LTE), zigbee, Sub 1 giga hertz, z-wave, mesh networking protocols such as Thread, or any other suitable wireless protocol. The communication device 74 may further include a port for wired data transfer 80 (via USB, or a standard network cable, for example). The power source 76 and/or the port 80 may provide a USB connection (such as standard USB, microUSB, miniUSB) suitable both to deliver power to the device and for data communication. The power source 76 may also be wirelessly chargeable, so that a wired charging port is not required.

The carer device 18 may include an alert mechanism for alerting a user of the device 18 including at least one of a visual display, a speaker, or a physical stimulus device. The carer device 18 may be operable to alert the user of the device 18 using one or more of those alert mechanisms in the event that an alert communication is received from one or more other devices in the system.

The carer device 18 may include a processor operable to process the carer sensor data generated by the sensors of the device 18. The data may be processed according to a set of rules, stored in a memory of the carer device 18 or otherwise hardwired or stored by the device, or through instructions received remotely from the cloud component. Where one or more of the rules is satisfied by the processed data, an alert is triggered on the device 18 and/or the alert is communicated to one or more other devices in the system. As discussed earlier in this specification, these rules can be updated by communication with another component of system 100 such as cloud component 16.

The carer device 18 may be configured to alert the carer using a visual, audio and/or vibration alert, in the event that the carer device 18 separated from the subject monitoring device 12 by more than a predetermined distance. The separation distance may be determined by GPS devices in one or both of the monitoring devices 12, 18, or by a detected loss of wireless signal between the devices (i.e. if the carer device 18 detects a drop in Bluetooth connectivity with the subject monitoring device 12, for example).

The system may include a plurality of carer devices 18.

### Smart Device

The smart device 14 may be a bespoke device tailored for operation with the system 10, 100 or may be a known smart device such as a smart mobile telephone, or smart wearable device, suitable for running an application providing the described functionality.

The smart device 14 includes a communication device 92 operable to send and receive signals wirelessly over a WiFi, Bluetooth, Fourth Generation Long Term Evolutions (4G/LTE), zigbee, Sub 1 giga hertz, z-wave, mesh networking protocols such as Thread, or any other suitable wireless or standard data connection protocol. The smart device 14 also includes a microprocessor 94 and memory 96. The microprocessor 94 and memory 96 are preferably suitable to process and store data sent to the smart device 14 from other devices within the system 10, 100. The smart device 14 includes an input device 98 and a display 102.

The smart device 14 may provide the functionality associated with a control device operable to control one or more other components within the system 10, 100. The following described aspects are associated with this control functionality. While this functionality is described in relation to the smart device, it should be understood that in embodiments providing base stations 20 (for example) those base stations may additionally or alternatively provide control functionality as described.

The smart device 14 may provide a facility for a user to input data manually to the smart device 14. For example, a carer may enter information about baby feeding times, so that the smart device 14 stores data relating to the times at which the subject being monitored (i.e. a baby in this case) is fed. The smart device 14 may provide a facility for other types of data to be input and stored, such as one or more of the following: details of an illness suffered by the subject being monitored (and/or the carer), the diet of the subject being monitored (and/or the carer), exercise or activities carried out by the subject (and/or the carer). This data may be stored, processed, transmitted and analysed with the data received from the other devices in the system 10, 100.

The smart device 14 may provide logging facilities to record data sensed by subject monitoring device 12 and/or the carer device 18. The data may be sent from the smart device 14 to the cloud component 16 for cloud-based storage. Data may be downloaded to the smart device 14 from the cloud component 16 for storage and/or processing on the smart device 14. Downloaded data may include one or more rules which smart device 14 may subsequently distribute to one or both of the subject monitoring device 12 and carer device 18.

The smart device 14 may provide monitoring rules for determining operation of devices within the system according to data sensed or otherwise recorded by the system 10, 100. The monitoring rules may be determined by the smart device 14 based on analysis of the data received by the smart device 14. For example, the smart device 14 may analyse data correlations between the feeding times of the subject, and the times at which the subject urinates. That correlation may describe a time delay occurring between the first and second events, of between 30 and 40 minutes on average. The smart device 14 may determine a rule that 40 minutes after the subject has been fed (as determined via a manual input to the smart device 14, for example), the smart device 14 reminds the carer to check the subject to determine whether the subject's clothing needs to be changed. This rule may be updated over time based on feedback including inputs from the carer or sensor data, for example, using a suitable machine learning algorithm. In this way, the action to be performed by the smart device 14 is updated to reflect system performance based on this feedback. The reminder may be provided via standard mobile telephone alert systems such as visual and/or audible alarms, vibration, or the like. Further or alternatively, a signal may be sent to the carer device 18 resulting in a vibration of that device 18, or an audible sound, or a visual display or an alert, to alert the carer. The rules generated by this process can be referred to as local rules as they are generated based on data in the local dataset as discussed earlier in this specification.

Where one or more rules are stored on the smart device 14 and used to process sensor data, an alert may be generated if one or more of the rules is satisfied. That alert may be displayed or otherwise enacted on the smart device 14, and/or communicated to one or more other devices in the system 10, 100, such as the carer device 18 for example.

The smart device 14 may provide the facility to input details of the subject's development, including its growth (e.g. weight, height, etc.), general health, etc.

The smart device 14 may be operable to manage the operation settings and operation rules used to generate alerts and advice based on the sensor data. The smart device 14 may be operable to provide advice based on the operating rules and analysis of the sensor data, in response to a demand from the carer or other user, or automatically at intervals or when triggered by particular operating rules based on the analysed data.

The smart device 14 may be operable to connect to social media applications to share and/or seek advice from other users of the system.

The system may include a plurality of smart devices 14.

### Base Station

System 100 may include a base station 20. The base station 20 may be supplied with differing functionality depending on the requirements of the user. For example, a ‘basic’ version of the base station 20 may provide a signal relaying and/or signal boosting functionality and/or charging facilities as described below.

Preferably, the base station 20 is located in the same room as the subject, so that there is a strong wireless communication link between the base station 20 and the subject monitoring device 12. For example, the base station 20 may form a part of a mobile device of the type that is positioned above or adjacent a baby's crib or cot and provides moving parts to entertain the baby.

The base station 20 includes a transmitting device 124, which comprises a transmitter and a receiver (which may be formed integrally as a transceiver). The base station 20 may comprise a signal-boosting device 26 for relaying signals received by one or more other devices in the system 100. For example, signals received via Bluetooth connection from the subject monitoring device 12 may be boosted and relayed with a higher signal strength for reception by the smart device 14 and/or carer device 18.

The base station 20 may be operable to retransmit received communications by one or more different protocols, to other devices in the system 100. For example the base station 20 may receive a Bluetooth signal from the subject monitoring device 12, which is then rebroadcast by the base station 20 via a WIFi signal, for receipt by the smart device 14 and/or carer device 18. Such rebroadcasting increases the range and/or strength of the original signal, and where the signal is relayed using one or more different protocols, allows different types of device to receive the signal.

The base station 20 may be situated nearby to the subject monitoring device 12, to ensure that the two are in communication. The base station 20 comprises a communication device 104 for relaying data to and/or from a remote source. The base station 20 also comprises a power source 106, which may be a battery, for example, or may be a socket/lead for connection to a wall power socket for receiving a wired power connection. The base station 20 may provide charging facilities to charge one or more of the smart device 14, the subject monitoring device 12 and the carer device 18.

The base station 20 establishes a stable communication link between the subject monitoring device 12 and the other components of the system 100. The communication device 104 is operable to transmit (and receive) data wirelessly over a WiFi, Bluetooth, Fourth Generation Long Term Evolutions (4G/LTE), zigbee, Sub 1 giga hertz, z—wave, mesh networking protocols such as Thread, or any other suitable wireless protocol. The communication device 104 preferably includes a port for wired data transfer 106 (via USB, or a standard network cable, for example), so that the base station 20 provides a wired connection to a network, and via the internet to the cloud component 16.

The base station 20 may provide ‘smart hub’ functionality that includes more advanced features in addition to the features of the ‘basic’ version. In such embodiments, the base station 20 is operable not only to relay communications from the subject monitoring device 12 to the smart device 14, but also to relay communications directly to the carer device 18, to ensure that the information is received immediately by the carer. For example the base station 20 may rebroadcast all communications of sensor data from the subject monitoring device 12, but may specifically direct any alert or warning communications to the smart device 14 and/or to the carer device 18.

Those direct communications may be via Bluetooth communication, or via WiFi, or via SMS, for example. If the base station 20 cannot establish contact with the smart device 14 and/or with the carer device 18 within a predetermined time period (of 5-15 seconds, or more preferably 10 seconds, for example), the base station 20 may raise an audible and/or visual alarm to attract attention to the alert or warning condition. The base station 20 may additionally require receipt of a communication from the smart device 14 or carer device 18 acknowledging that the alert or warning message has been received and is being acted upon. Where no such receipt is received, the base station 20 may raise an alarm as previously described.

The base station 20 may include a display 122 for displaying information to the carer, such as data communicated to the device 20 by other components in the system 100, or for displaying status information relating to the device 20 (such as power status, operating status, connectivity status, for example). Status information may be displayed on a screen, or via LEDs, or by any other means.

The display 122 may provide a touch screen for a user to interact with the base station 20 to change operating settings, or the like. The base station 20 may provide additional input devices 124 such as buttons, dials, switches, or the like.

The base station 20 may provide advanced functionality in addition to the above-described functionality of the ‘basic’ and ‘smart hub’ versions, as follows.

In such ‘advanced’ embodiments, the base station includes a memory 120 and a microprocessor 112. In a similar manner to the smart device 14, the base station 20 may provide the processing power required to perform calculations on the data stored in the memory 120, to determine patterns, anomalies and/or changes in the data detecting by the sensors 108 or received by other devices in the system 100. The memory 120 and/or microprocessor 112 may determine and/or store operational rules and settings for the base station 20, to determine how it should operate. The base station 20 may receive instructions, rules, and/or updates to existing instructions and/or rules from the cloud component 16 in the manner discussed earlier in respect of the subject device.

As described in relation with the control device functionality that may be provided by the smart device 14, the base station 20 and/or smart device 14 may be configured to determine and/or store operation rules for one or more of the subject monitoring device 12, the carer device 18, the smart device 14, and/or the base station 20, which may be communicated to one or more of the devices in the system 100 to update their respective operating instructions.

The base station 20 optionally further comprises at least one sensor 108, for detecting a condition of the environment of the subject. The base station 20 may include at least one of a thermometer 114, and/or a microphone 116, and/or a light sensor 132. In embodiments providing a microphone 116, the base station 20 may record sounds received by the microphone 116 and/or transmit those sounds to a remote device in the system 100. Similarly, the base station 20 may store data generated by the thermometer, indicating the temperate of the environment around the subject.

The base station 20 may be configured to compare data from a thermometer 114 provided in the base station 20, with data received from the subject monitoring device 12 taken by its own thermometer 52. The base station 20 may sense discrepancies between the two readings, indicating that a heat source is close to one or other of the thermometers, for example, or that one of the thermometers is positioned in direct sunlight or in a draught which is lowering the observed temperature. In this way, the system 100 may detect environmental causes of temperature fluctuations, and store those detected causes with the stored data. In embodiments, the base station 20 may communicate with the smart device 14 and/or with the carer device 18 to alert the carer or another user to the discrepancy in temperature. For example, if the subject is in a position at which a draught is felt and the temperature sensed by the subject-monitoring device 12 is significantly lower than the temperature sensed by the base station 20 (i.e. the difference is greater than a pre-determined threshold) then an alert may be sent to the smart device 14 so that the carer is notified, and may then reposition the subject (i.e. a baby in a cot, for example), so that it is no longer subject to the cooling draught.

In a similar manner, the base station 20 may raise alerts and/or store data sensed by the microphone 116, if the noise sensed is louder than a pre-determined threshold. The sound levels sensed by the microphones in the subject monitoring device 12 and the base station 20 may be compared. For example, if the sound sensed at the subject monitoring device 12 is significantly louder than the sound sensed at the base station 20 a short distance from the subject monitoring device 12, it is likely that the sound is emanating from the subject. For example, this may indicate that the subject is crying, whereas a vehicle passing outside the building may make a noise that is just as a loud, but is sensed at an equivalent level at each microphone. The base station 20 may communicate an alert to another device

In embodiments where a light sensor 132 is incorporated, the sensor may be used to indicate the brightness in the environment of the subject being monitored. This information be used to determine possible causes of an infant waking, for example.

The base station may include a speaker 126 and/or a projector 128. The speaker 126 is operable to broadcast sounds such as music, or the voice of a parent, for example, in the environment of the subject being monitored. This may provide a soothing effect, as an aid when an infant is falling asleep. In addition, the speaker 126 may be used to sound an alert or alarm.

In embodiments providing a projector 128, the projector may be activated to display an engaging image (such as a cartoon, for example) on a wall or ceiling. This may comfort a child being monitored, for example. The projector 128 may be used to soothe a child that has woken during the night, to lessen the likelihood of the child crying.

The base station 120 may include a control unit 130 operable to control aspects of the environment of the subject being monitored. In addition to the functions of providing sound and projection, as described above, the control unit 130 may be operable to control lighting within the room (by turning lights on/off, or dimming/brightening lights, or by drawing blinds, for example). The control unit 130 may be operable to control a heating device, to raise or lower the temperature in the room. The control unit 130 may be operable to control a fan or air conditioning unit, to provide an air flow within the room.

To summarise this aspect of the system in general terms, a control device within the system is operable to determine a status of the subject (such as ‘crying’ or ‘awake’) based on processed sensor data according to a set of rules stored on the control device (which may be supplied from the cloud component 16, for example). The status may be such that action is required (for example, to calm the baby to stop it crying, or pacify the baby so that it goes to sleep).

Such a status is established where one or more of the rules is satisfied by the processed data—e.g. the system identifies from the microphone data the baby is crying, or from the accelerometer data it is determined that the baby is awake and wriggling.

Where the status requires action, the base station 20 is operable to control aspects of the environment of the subject in response to that status. The status may be communicated from the cloud component 16, or from the smart device 14, for example. In such cases, the base station 20 control unit does one or more of the following: playing sound using a speaker, projecting or displaying an image, controlling one or more lighting units, controlling one or more heating devices, controlling a fan or air conditioning unit.

The system may include a plurality of base stations 20.

### Cloud Component

The system 10, 100 may provide connectivity to one or more cloud storage devices and/or cloud processing devices. In such embodiments, sensor data obtained from the subject monitoring device 12 and carer device 18 may be uploaded to the cloud component 16 for storage. The data may be uploaded directly from the monitoring devices 12, 18, or may communicated to one or more of the smart device 14 and base station 20, and subsequently uploaded.

Data may be processed by one or more control devices 14, 20 within the system prior to being uploaded to the cloud component 16. This processing may involve any of: sorting, removing duplicates, categorising, aggregating and averaging. Optionally, further processing may occur at cloud component 16. Alternatively, raw or minimally processed data is received at the cloud component 16 and then subjected to one or more processing techniques as discussed.

Preferably, data from multiple monitoring devices is uploaded to a shared cloud component 16 resource to create the global database discussed earlier in this specification. An “API” based interface may also be available for integration of other devices.

Data from multiple systems 10, 100 can be uploaded to a shared cloud component 16 resource, each system 10, 100 providing one or more monitoring devices 12, 18, and control devices 14, 20. For example, a system may be implemented by a family to monitor the wellbeing of a baby (the subject) and its parent or guardian (the carer). The system may include a subject monitoring device 12, a carer device 18, a smart phone device 14, and a base station device 20. The system may upload data from those devices to a cloud component 16. That cloud component 16 may also receive data from other families each having their own monitoring devices and control devices.

In such embodiments, the data received at the cloud component 16 provides a far greater sample from which to observe patterns, and from which to predict future patterns and behaviour, for the purpose of developing control rules for operating the one or more control devices in the systems 10, 100. As mentioned earlier in this specification, this is particularly advantageous when reviewing patterns in data to predict illnesses based on symptoms and behaviours, where a greater sample size provides far greater clarity and certainty.

Further, when establishing a new system 10, 100 for monitoring a family, the control rules applied to the devices within the system may be set using rules developed from data aggregated from many other families. Preferably rules are generated and revised based on data from both the subject and carer, so that the behaviours of both the subject and carer are captured and analysed. It will also be appreciated that the system can be readily extended to monitor, capture and analyse behaviours corresponding to other persons that also frequently interact with the subject; for example, siblings, grandparents, non-family members such as lodgers or tenants, and potentially even pets. Each of these persons can be provided with a monitoring device like subject monitoring device 12 or carer monitoring device 18 as appropriate to their social status within the family to enable data capture and to enhance the analysis performed by cloud component 16. Operational rules may be generated and/or updated based on the aggregated data from an entire family, potentially enhancing the efficiency and/or effectiveness of alerts generated by the system.

The sensor data stored at the cloud component 16 may be processed in the same way as explained in relation to the control devices within the system to provide monitoring rules for determining operation of devices within the system according to data sensed or otherwise recorded by the system 10, 100. The cloud component 16 may provide updates to the one or more control devices (e.g. at prescribed intervals, or when an update is requested by a user), to refine the performance of the system 10, 100.

### System Operation

With reference to FIG. 1 of the drawings, a system 10 is provided that includes a subject monitoring device 12, and a carer device 18, as described above. The two monitoring devices 12, 18 communicate with a control device which, in this case, is illustrated as a mobile “smartphone” (referred to as a smart device 14). As shown at ‘A’, and set out in FIG. 3, the subject monitoring device 12 communicates (A1) sensor data from the sensors 22 (or memory) of the device 12 to the smart device 14. The smart device 14 communicates (A2) instructions and/or operating rules to the subject monitoring device 12. The instructions include requests for information (such as further sensor data readings), instructions to operate one or more components of the device 12, or rules for operation of the device 12. The rules may be based at least in part on the results of machine learning algorithms performed at a global and/or local level, as discussed earlier in this specification.

By the term ‘sensor data’, we mean any data that is recorded by one or more of the sensors used in the system. This is intended to include data that has been manipulated (i.e. rounded, averaged, categorised) as well as raw data. It is further intended to include data that indicative of the data recorded by sensors, subsequently retrieved from a memory device and/or communicated between one or more devices in the system 10, 100, rather than solely data received directly from a sensor, for example.

The smart device 14 communicates (B) with the carer device 18 in a similar manner, as shown in FIG. 4, wherein the carer device sends (B2) sensor data from the carer device 18, and instructions relating to the monitoring of the subject monitoring device 12, to the smart device 14.

A control device within the system (such as a smart device 14, as shown at B1) may communicate alerts and/or status updates to the carer device 18. The control device may also communicate sensor data relayed from the subject monitoring device 12 and/or from the base station 20 to the carer device 18.

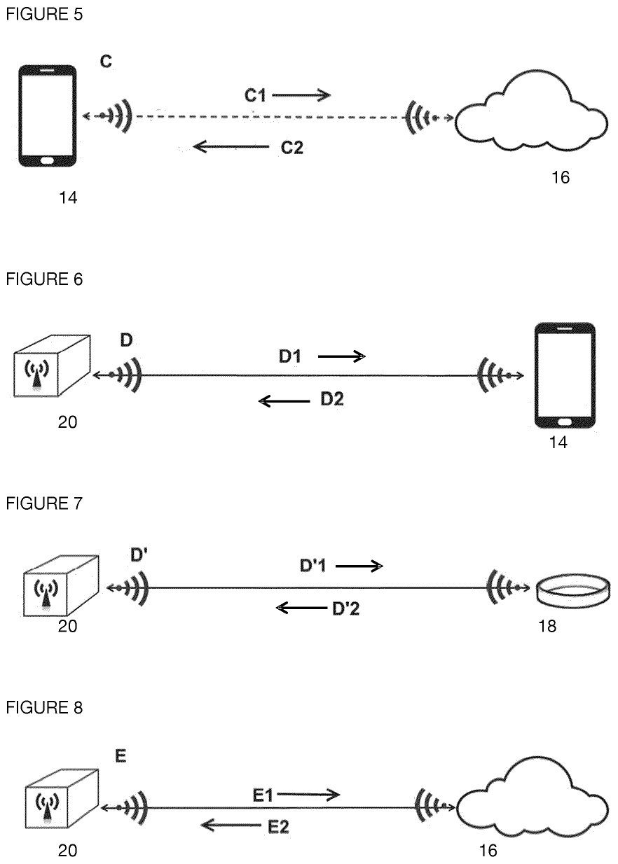

With reference to FIG. 5, the smart device 14 (or any other control device) may communicate sensor data (C1) (whether processed or otherwise) to the cloud component 16.

The smart device 14 (or other control device) may further communicate system operating information including user-defined (i.e. options or settings chosen by a user) or system-defined settings (i.e. options and settings determined by the applications/software/firmware running on the devices within the system) to the cloud component 16. In this way, if an error occurs in the devices within the system—or a device is lost or damaged and subsequently replaced—the system settings may be recovered from the cloud component and reset on the relevant devices.

The cloud component 16 may communicate (C2) analysis reports, advice, software/firmware updates, and/or updated operating rules and settings to the control device(s) 14, 20 in the system as previously described.

The communication C between the cloud component 16 and control devices 14, 20 may be intermittent, so that data is sent or received only at intervals, or on demand from a user input at the control device, for example.

With reference to FIG. 6, the base station 20 and smart device 14 may communicate (D) with each other. The base station 20 may communicate D1 data (including sensor data) received from the subject monitoring device 12 to other devices within the system 100, including the smart device 14. The communication D1 may comprise an enhanced/boosted signal, and/or may be made using a different communication protocol than the one used to communicate between the subject monitoring device 12 and the base station 20.

The smart device 14 may communicate (D2) to the base station 20, to provide instructions to update or modify the behaviour of the base station 20. The smart device 14 may communicate instructions to turn on or off components of the base station 20 (such as playing music via the speaker 126, turning the projector 128 on or off, or to control aspects of the environment of the subject affecting the lighting conditions, heating conditions, or the like, as previously described).

As shown in FIG. 7, the base station 20 may also communicate directly (D′) with the carer device 18. These communications D′1 may provide status updates and/or alert and/or warning information directly to the carer device 18 (which may cause the device 18 to vibrate, or to provide a visual and/or audio signal to the carer). The communicated updates/alerts/warnings may be determined by analysis of sensor data carried out at the base station 20, in embodiments in which the base station 20 provides analysis functionality.

The carer device 18 may communicate D′2 instructions to update or modify the behaviour of the base station 20, as described above in relation to the communications D2 provided by the smart device 14.

FIG. 8 illustrates communications (E) between the base station 20 and the cloud component 16 where, sensor data is communicated E1 to the cloud component 16 for storage and/or further processing. In addition, or alternatively, the base station 20 may communicate hardware or software diagnostic information, including details of the operational status of one or more components of the base station 20 to the cloud component 16. This diagnostic information may be analysed at the cloud component, to determine correct operation of the base station 20. Alternatively, other devices within the system 100 may communicate diagnostic information to the base station 20, which may be stored at the base station 20.

The cloud component 16 may communicate operating instructions and/or operating rules to the base station 20 to control aspects of the performance of the base station 20. Firmware and/or software updates may be provided to the base station 20, to update the performance and operation of the base station 20. The firmware and/or software updates may relate to one or more other devices in the system 100, for subsequent communication to those respective devices from the base station 20.

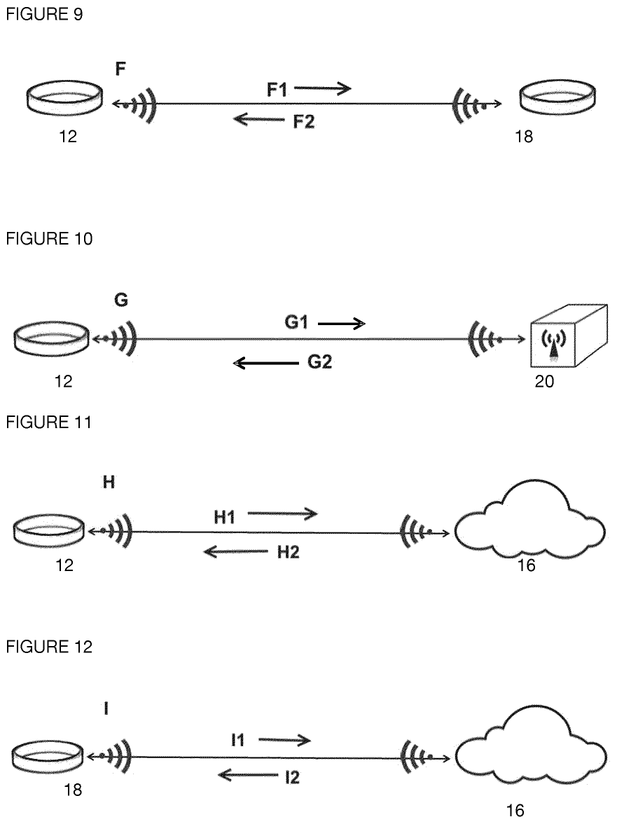

FIG. 9 illustrates communication (F) between the monitoring devices 12, 18 (i.e. the subject monitoring device 12 and carer device 18), in embodiments of the system 100. The subject monitoring device 12 is configured to send alerts and/or status updates directly (F1) to the carer device 18. On receipt of such alerts/updates, the carer device 18 is configured to alert the carer by an audible alert, visual alert and/or vibration. In this way the carer is made aware of problems with the subject being monitored as soon as possible, without requiring the communications to be relayed via control devices (such as the base station 20 and smart device 14).

The carer device 18 may be configured to enable the carer to input instructions to be communicated F2 to the subject monitoring device 12, to alter the operation of the device 12 (for example, to turn off an alarm, or request further sensor data from the device 12).

As shown in FIGS. 2 and 10, the subject monitoring device 12 may be operable to communicate G with the base station 20. The subject monitoring device 12 communicates G1 sensor data to the base station 20. The base station 20 is configured to communicate G2 instructions and/or operating rules to the subject monitoring device 12, to update the behaviour of the device 12.

As shown in FIGS. 11 and 12, the subject monitoring device 12 and/or carer device 18 may be operable to communicate (H, I) with the cloud component 16. The monitoring devices 12, 18 are operable to communicate H1, I1 sensor data to the cloud component 16 for storage, and the cloud component 16 is operable to communicate (H2, I2) operating instructions and/or operating rules to the respective subject monitoring device 12 and carer device 18.

One or more of the devices within the system 10, 100 may be operable to provide an alert where it is detected that power to the device is lost, or where the remaining charge in a battery connected to the device is determined to have dropped below a threshold (e.g. the charge is below 10%, or below 5% of the total capacity). Where an ‘alert’, ‘alarm’ or ‘warning’ condition is described, one or more of the devices in the system 10, 100 may provide one or more of a visual indication, an audible indication, a vibratory indication.

When an alert/alarm/warning is raised by any device within the system 10, 100, one or more of the control devices (i.e. the smart device 14 and/or the base station 20 may provide an alert as described above, and/or contacts one or more of the other devices to cause that device to provide an alert.

In use, the systems 10, 100 of the present invention provide monitoring of a subject person, via the subject monitoring device 12. The system 10, 100 provides three fundamental abilities:
1) to record the condition of the subject and/or the environment of the subject and/or the condition of the carer;
2) to analyse the recorded conditions and provide status and alert information to a carer and
3) to log the activities of the subject, the carer and/or the environment of the subject, to observe correlations between the activities and observed conditions related to well-being of both, so as to improve the future routine of the subject/carer through provision of advice and/or through updates to the routine for the subject and/or carer. These updates may be provided at least in part by updated rules for various components of the system in the manner described earlier in this specification.

### Recording the Condition of the Subject

Using the systems 10, 100, 200 of the present invention, a carer is able to collect data on the timing, duration and quality of a baby's sleeping, eating, nappy changes and play-time. All of this data may affect a baby's adherence to a routine. Data may also be collected on other aspects of the subject's routine, including times spent crying, being unwell, episodes of bad behaviour, for example.

Sensor data recorded by the subject monitoring device 12 may be processed by a device within the system 10, 100, 200. One or more of the subject monitoring device 12, smart device 14, cloud component 16, carer device 18 or base station 20 may be configured to analyse the sensor data to determine one or more activities of the subject. For example, data from the accelerometer and heart rate monitor may be indicative of a breathing motion. A regular breathing motion meeting predetermine criteria may be indicative of the subject being asleep. The threshold for determining whether the subject is adjudged to be asleep may be redefined by the system during operation, according to the operating rules, as previously described.

Data from the microphone may be used to indicate breathing and/or sleeping. Additionally or alternatively, a video camera may be provided adjacent a cot or crib, and image analysis may be used to determine whether the subject is asleep. Additionally or alternatively, the heart rate monitor data may be used to indicate that the subject is asleep. A carer may additionally or alternatively make a manual input to the carer device 18 and/or the smart device 14 (and/or the base station 20) to indicate that the subject is asleep.

The heart rate sensor data and/or the sensed breathing rate may be used to indicate when the subject is eating Alternatively or additionally, the carer may input manually to one or more of the devices in the system that the subject is eating (the input device may be the smart device 14, or the carer device 18, or on the subject monitoring device 12, for example).

The system may determine from the recorded sensor data when the subject is being breast-fed. A combination of one or more of the following factors may be assessed to determine whether breast-feeding is taking place: the gyroscopic position of the subject monitoring device 12 and the carer's device 18, the proximity of those two devices, pressure caused through contact with the mother, the skin temperature of the subject, the heart rate of the subject, the heart rate of the carer (i.e. mother), the breathing rate of the subject.

The relative positions of GPS units in the subject monitoring device 12 and carer device 18 may be used to determine whether breast-feeding is likely to be taking place.

Relatively close GPS positioning (or any other proximity detection) of those devices 12, 18 triggers monitoring of one or more of the factors listed above for determining whether breast-feeding is taking place.

The system may determine the relative angular positions of the subject monitoring device 12 and carer device 18 (via the gyroscopic sensors, for example). Where the angular positions lie in particular ranges, and the relative positions like within a certain predefined range, the system may determine that the subject baby is being held in a position for feeding, and that the carer's arm (for example) is positioned to hold the baby in a suitable position for breast-feeding. From this information, the system may determine that breast-feeding is taking place. This assessment may be confirmed by a manual input from the carer using the carer device 18 or smart device 14, for example. Where confirmation is received, the system may log this sensor information and use it in future analysis, as an example of a confirmed feeding position.

The system may determine from recorded sensor data whether the subject is crying. A combination of one or more of the following factors may be assessed to determine whether the subject is crying: microphone input of the microphone of the subject monitoring device 12, relative microphone input when compared to another microphone within the system, heart rate, breathing, and accelerometer readings.

The carer may input manually to one or more of the devices in the system that the subject has its clothing changed (i.e. a nappy or diaper). One or more sets of sensor data and/or a manual input may be used to indicate that the subject is playing (or otherwise carrying out strenuous activity).

The system 10, 100, 200 may be operable to detect the temperature of the skin of the subject. One or more set of sensor data and/or a manual input may be used to indicate that the subject is unwell (which manual input may include details of the symptoms or other details of a diagnosis, for example).

In embodiments including a temperature sensor such as a thermometer, the system 10, 100, 200 is operable to detect the temperature of the environment of the subject. The system may additionally or alternatively be operable to detect noises and/or light levels in the environment of the subject.

### Recording the Condition of the Carer

In addition to collecting and analysing sensor data from the subject monitoring device 12, the carer device 18 may also provide sensor data to one or more control devices within the system 10, 100, 200 for analysis. The system 10, 100, 200 may determine from the sensor data indications of when the carer is asleep, heart activity (such as blood pressure and/or heart rate), and indications of the activity levels of the carer. This information may be analysed by a control device in the system to determine the well-being of the carer. This analysis can also be extended beyond the carer to other persons of interest, such as a grandparent or a sibling, as discussed earlier in this specification. In such cases the additional person(s) would also be provided with a monitoring device such as carer device 18 (e.g. grandparent) or subject monitoring device (e.g. sibling) depending on their social status.

### Analysis of the Condition of the Subject/Carer

One or more control devices in the system are operable to analyse sensor data recorded by the system. Analysis of data relating to sleep conditions may include one or more of the following: crib comfort (via a manual input based on a carer assessment), temperature (based on a thermometer reading and/or thermostat setting), noises (based on a microphone reading), light levels (based on a light sensor reading), clothing (based on a manual input), nappy changes (based on manual inputs), sleeping position (based on gyroscopic or pressure sensor data), teething status (based on a manual input), hunger (based on inputs relating to feeding routine), stomach problems (based on manual inputs), disease (based on breathing rate, skin temperature, heart rate, and manual input), sleep location (based on manual input and/or GPS location), and the person putting the subject to bed (based on proximity data of the carer and/or manual input).

Analysis of data relating to eating may include one or more of the following: breast-feeding or milk formula feeding (based on manual input), reflux, allergy information, stomach problems, types of foods, and mother's diet (if breast-feeding), each based on manual inputs.

Analysis of data relating to nappy/diaper changes or play time may include analysis of one or more of the following: breastfeeding or milk formula feeding, types of food, water intake, and stomach problem information, all based on manual inputs.

In general terms, information about the subject's routine may be collected based on one or more of the following factors: accelerometer readings, pressure sensor readings, gyroscopic sensor readings, microphone readings, light sensor readings, manual inputs, proximity readings, breathing rate, heart rate, video surveillance, and GPS location readings.

Activities that are identified through analysis of sensor data, or manual inputs, are logged as historic records. These logs can be correlated with other data about the health of the subject, or other conditions of the subject or its environment, so that patterns between various factors may be identified. For example, patterns in temperature, light levels, feeding times and nappy/diaper changing times may be correlated with sleep patterns. From this information, the system may provide advice to the carer to change aspects of the routine of the subject (for example, the subject sleeps longer when fed and changed earlier). This information may be stored in the local database and/or uploaded to the global database. Machine learning algorithms may be applied to one or both databases, which algorithms may be the same or different. Results of this analysis may be fed back into the system by way of refinement of one or more operational rules used to dictate the behaviour of any component or components of system 10, 100, 200.

The data and activities may be logged based on date and time, so that correlations in weekday/weekend routines can be assessed, for example. Further the age of the subject being monitored may be taken into account when determining advice or updates to operating rules and instructions.

The system may determine that the carer has low activity levels over a prolonged period of time, which (alone or in combination with other factors) may indicate that the carer is at risk of suffering depression. The system may generate advice for the carer and/or may be operable to contact a third party to make that party aware that the carer may need attention.

The sensor data collected from the carer device 18 may also be logged and processed by the system 10, 100, 200 separately or in combination with the sensor data collected from the subject monitoring device 12. By analysing the combined data, the system may detect patterns occurring between the actions or state of the carer and the well-being and routine of the subject, and advise or update system behaviour accordingly. Further, data from the carer device 18 may be used to monitor the health and well-being of the carer using the same or similar rules and instructions used by the system to monitor the health and well-being of the subject, using the same computational features as described elsewhere in this specification.

### Provision of Alert and Status Information

The system may provide immediate advice to the carer via alerts on the subject-monitoring device 12, via alerts on the carer's device 18, via an application on the smart device 14, or via any other system device. The immediate advice may be in the form of messages such as “put the baby to sleep”, “wake baby up”, “soothe baby back to sleep”. More long term advice on issues relating to routine, may be in the form of advice dispensed through an application on a smart device 14, via a desktop/browser application, via SMS, via mobile applications such as ‘Whatsapp®’, or via automated telephone calls. The long term advice may in the form of the following examples: “at this age your baby needs X hours of sleep”, “start feeding solids this week”, or “start potty training this month”.

When the system detects that the subject is awake in the night, the control device(s) may determine, possibly based on updatable rules, whether or not to a) allow the subject to stay awake and take no action, b) allow the subject to stay awake and alert the carer, or c) attempt to send the subject to sleep. Where the subject is to be sent to sleep, the system may operate one or more of: a speaker playing music; a speaker playing the sound of a carer's voice; a speaker playing white noise, a pressure band or pressure pad operable to apply pressure to the subject, issuing a soothing fragrance, applying a pacifier to the subject. If the subject is to be kept awake and entertained, the system may provide visual effects to calm and/or occupy the subject (using the projector, for example), or play music via the speaker, or operate a toy positioned close to the cot or crib.

Over time, the system may be operable to improve its recognition of when the subject is crying or being breast-fed, for example, by comparing the analysed data observed at those times with manually entered records indicating that those activities were taking place. In this way, machine learning algorithms can adapt pattern classifiers (or any other learning algorithms, such as artificial neural networks, for example) to learn to recognise activities based on data obtained from the sensors in the system.

The system 10, 100, 200 may generate operating alerts to indicate one or more of the following conditions: battery charge being below a predetermined level, disruption of power supply to a device, a device being damaged, and a connectivity loss between two or more devices within the system.

The system 10, 100, 200 may generate alerts (‘warnings’) where the system detects that: a monitoring device has fallen (e.g. using sensor data, such as data from the accelerometer); a heart monitor records no pulse or heartbeat; sensor data indicates that the subject or carer has stopped breathing; the sensor data indicates that the subject is lying on its stomach; the subject skin temperature is sensed below a lower threshold or above an upper threshold.

In other circumstances, the output of a gyroscopic sensor and/or accelerometer may indicate that the subject (where the subject is a baby, for example) has rolled on to its stomach and is lying on its stomach. Such a position may potentially put the baby at risk of SIDS (‘sudden infant death syndrome’), and a corresponding alert/warning may be generated.

### Storing Data and Updating Rules for Alerts and Monitoring Algorithms

The system 10, 100, 200 allows integration of data about the routine of a baby (or other subject) and possible factors affecting that routine. By analysing the sensor data collected by the system 10, 100, 200, and comparing the data to previously-observed data, data relating to a large population of healthy/unhealthy babies, and/or best practice guidelines, the system is operable to identify ways to improve the routine and environmental conditions affecting the baby.

The system provides two general outputs. First, the system provides advice and/or alerts provided to the carer, to allow immediate updates to the routine or environment conditions (such as ‘wake the baby up now’, or ‘wait one more hour until feeding’, or turn up the temperature overnight in the baby's room). Second, the system provides long-term advice based on patterns identified in a larger population sample (i.e. analysed by the cloud component) or from historic data samples, rules and advice input into the system. This long-term advice may be in the form ‘this month you can introduce solid food to the baby's diet’, for example.

Furthermore, updating the behaviour of system components such as the base station 20, and the subject-monitoring device 12, may result in automated ways to improve the routine without further input from the carer. For example, the system 100 may be operable to raise the lighting in the baby's room, and play soft music, to aid the baby getting back to sleep having woken in the night. The local database may store historical data that allows an adaptive algorithm such as a machine learning algorithm or artificial neural network to assess the effectiveness of such techniques for returning a specific baby to sleep, for example, to allow corresponding operational rules to be updated or generated. The system may thus advantageously be tailored to operate efficiently and/or effectively with respect to a particular subject.

One or more control devices within the system 100, 200 may be configured to receive data input by a user either via a user input device provided by the control device (in the case of a smart device 14 or base station 20, for example) or by receiving a communication indicative of the input data from a remote device (such as from the carer device 18, for example).

The control device processes the user input data by comparing it with data provided from the sensors of the subject monitoring device 12, to establish patterns between the measured data from the sensors and the data manually input by a user. The user inputs provide classifications of the actions occurring at any given time, which can be correlated with the sensor data. In this way, the data can be processed according to a first set of rules so as to determine a second set of rules for categorising sensor data received from the subject sensor so as to determine a status of the subject based on the sensor data. In other words, the system analyses user input data—such as feeding times, nappy-changing times, activity levels, and sleep patterns, for example—and from that data generates classifications of the activity likely to be occurring based on data received from the sensors at any time. The categories may include ‘feeding’, ‘sleeping’, ‘crying’, ‘unwell’, ‘playing’, for example. In this way, the system may learn to develop its own rule set for establishing when these activities occur in the future, based on manual inputs by the carer.

Where future sensor data is processed, a revised set of rules may be applied to determine the current activity of the subject. Where the subject is found to be crying or unwell (for example) and in need of attention, the system may alert the user or may operate functions of the base station 20 (for example) to calm or soothe the subject.

As described earlier in this specification, the data collected from multiple systems employed in respect of other subjects may be collated in the cloud component, and used to provide this classification information.

### Example System

An example system layout is set out in FIG. 22, in which a system 200 is provided, having a subject monitoring device 12 configured to communicate G1 sensor data to a base station 20. The subject monitoring device 12 may be a wearable device, and may contain a microprocessor and may be operable to perform basic calculations. The base station 20 is operable to store the sensor data in a memory.

The base station 20 is also configured to receive data from a carer device 18. A carer device 18 communicates D′2 sensor data from the sensors of the carer device, including accelerometer data for example. The communicated data may also include manually input data, relating to feeding times and nappy change times corresponding to interactions between the carer and the subject. The carer device 18 may be a wearable device, and may contain a microprocessor and may be operable to perform basic calculations.

The base station 20 communicates sensor data (and any manually entered data) from the subject monitoring device 12 and carer device 18 to the cloud component 16. The cloud component 16 stores the data received from the base station 20. The system further includes a smart device 14, which in this example is a mobile smartphone. In this system 200, the smartphone acts as a control device.

The cloud component 16 may perform analysis on that data using e.g. machine learning algorithms or an artificial neural network to determine updates or amendments to operating instructions and/or operating rules applicable to smart device 14, for example. The cloud component 16 may also determine advice to provide to the carer, based on the analysis of the data, to remedy any issues or deficiencies identified in the routine of the carer or subject, or in the environment of the subject. The advice may be generated according to classification of the data to fit specific criteria or thresholds, and/or may be generated by a comment system operable to provide peer support, and/or may be generated using other data analysis techniques by categorising patterns observed in the data set. The advice may include text aimed at informing and/or educating the carer, and/or may include suggested revisions to operating rules and/or operating instructions and settings used in the system.

The advice and/or data (whether the ‘raw’ sensor data or a refined form of that data) is communicated C2 to the smart device 14 for display to the carer. The smart device 14 communicates C1 inputs from the user (i.e. the carer), and/or operating rules and/or operating settings to the cloud component 16. The operating rules may also or alternatively be updated by the cloud component 16, as previously described.

In operation, under the conditions imposed by the operating rules and operating settings of the system 200, on receipt of data that matches alert, status, or warning triggers, the cloud component communicates alert information and/or status updates and/or warning information to the base station 20. Status updates or alerts/warnings may be displayed or otherwise enacted at the base station 20, and/or may be communicated D′1 to the carer device 18 to alert/warn/update the carer based on the data analysis in the cloud component 16.

Unless otherwise stated, all features of all embodiments of the invention described herein are combinable with all other features, in any desired combination.

When used in this specification and claims, the terms “comprises” and “comprising” and variations thereof mean that the specified features, steps or integers are included. The terms are not to be interpreted to exclude the presence of other features, steps or components.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilised for realising the invention in diverse forms thereof.

1. A system for monitoring the well-being of a subject person and/or carer, comprising:
a subject monitoring device including:
a subject sensor operable to detect a subject condition of a first subject or the environment of the first subject, and a subject communication device;
a carer device associated with a first carer and including: a carer sensor operable to detect a carer condition of the carer and a carer communication device; and
a control device including: a processor, a memory, and a communication device operable to be communicatively coupled with the subject monitoring device and with the carer device, and configured to:
receive first sensor data indicative of the subject condition from the subject monitoring device;
receive second sensor data indicative of the carer condition from the carer device;
store the first and second sensor data in the memory;
process the first and second sensor data to observe correlations between the subject and carer conditions; and
based on the processed first and second sensor data at least one of: determine a status and and communicate the determined status to the carer device; and determine and/or refine operational rules.

2. (canceled)

3. (canceled)

4. (canceled)

5. (canceled)

6. The system of claim 1, wherein the first and second sensor data is stored in a first database, wherein the first database is one of:
a global database that contains first and second sensor data corresponding to a plurality of subjects and a plurality of carers, wherein the first sensor data for each of the subjects is indicative of the subject condition of the respective subject, and wherein the second sensor data for each of the carers is indicative of the carer condition of the respective carer;
a local database that contains the first and second sensor data corresponding to the first subject and first carer only; or
a combined global and local database that contains the first and second sensor data corresponding to a plurality of subjects and the first subject and also contains the first and second sensor data corresponding to a plurality of carers and the first carer.

7. The system of claim 6, wherein the control device is configured to process the first and second sensor data in the first database using at least one of a machine learning algorithm and an artificial neural network.

8. The system of claim 1, wherein the subject monitoring device includes a plurality of subject sensors, wherein the first sensor data is indicative of a corresponding plurality of subject conditions.

9. The system of claim 1, wherein the or each subject sensor is one of the following: an accelerometer, a thermometer, a gyroscopic sensor, a bio-impedance sensor, a galvanic skin sensor, a heart-rate monitor, a magnetometer, a global positioning system receiver, a microphone, and a pressure sensor.

10. The system of claim 1, wherein the subject monitoring device is a wearable device for attachment to the skin or clothing of a person.

11. (canceled)

12. (canceled)

13. (canceled)

14. (canceled)

15. (canceled)

16. A method of operating a system for monitoring the well-being of a subject person, the system comprising a subject monitoring device for detecting a subject condition of a subject or of an environment of the subject, a carer device for detecting a condition of the carer, and a control device, the method comprising the steps of:
communicating first sensor data indicative of the subject condition from the subject monitoring device to the control device;
communicating second sensor data indicative of the carer condition from the carer device to the control device;
storing the sensor data in a memory of the control device;
processing the first and second sensor data at the control device to observe correlations between the subject and carer conditions;
based on the processed first and second sensor data determining a status and communicating the determined status from the control device to the carer device, or determining and/or refining operational rules.

17. (canceled)

18. (canceled)

19. (canceled)

20. (canceled)

21. (canceled)

22. (canceled)

23. (canceled)

24. (canceled)

25. The method of claim 18, wherein the first and second sensor data is stored in a first data base, wherein the first database is one of:
a global database that contains first and second sensor data corresponding to a plurality of subjects and a plurality of carers, wherein the first sensor data for each of the subjects is indicative of the subject condition of the respective subject, and wherein the second sensor data for each of the carers is indicative of the carer condition of the respective carer;
a local database that contains the first and second sensor data corresponding to the first subject and first carer only; or
a combined global and local database that contains the first and second sensor data corresponding to a plurality of subjects and the first subject and also contains the first and second sensor data corresponding to a plurality of carers and the first carer.

25. The method of claim 16, wherein the control device is configured to process the first and second sensor data in the first database using at least one of a machine learning algorithm and an artificial neural network.

27. The method of claim 16, wherein the subject monitoring device includes a plurality of subject sensors, wherein the first sensor data is indicative of a corresponding plurality of subject conditions.

28. The method of claim 16, wherein the or each subject sensor is one of the following: an accelerometer, a thermometer, a gyroscopic sensor, a bio-impedance sensor, a galvanic skin sensor, a heart-rate monitor, a magnetometer, a global positioning system receiver, a microphone, and a pressure sensor.

29. The method of claim 16, wherein the subject monitoring device is a wearable device for attachment to the skin or clothing of a person.
